(19) United States
(12) Patent Application Publication
(10) Pub. No.: US 2005/0114281 A1
(43) Pub. Date: May 26, 2005

(54) Quantitative assessment tool

(76) Inventors: Jeffrey L. Riggs, Gaithersburg, MD (US); Holland Coulter, Hendersonville, NC (US); Jennifer Lefeaux, Gaithersburg, MD (US)

Correspondence Address: Hoffman, Wasson & Gitler, P.C.;Suite 522, 2461 South Clark Street, Crystal Center 2, Arlington, VA, 22202, US

(21) Appl. No.: 10/995,280

(22) Filed: Nov. 24, 2004

Related U.S. Application Data
(60) Provisional application No. 60/524,649, filed on Nov. 25, 2003.
(60) Provisional application No. 60/545,528, filed on Feb. 19, 2004.

(51) Int. Cl. G06N 5/02; G06F 17/00; G06N 7/00; G06N 7/08

(52) U.S. Cl. 706/46

(57) ABSTRACT

A mathematically rigorous process for evaluating and prioritizing decision alternatives in an operational management or fiscal decision environment using a quantitative assessment tool (QAT). It employs current multi-criteria decision-theoretic methodologies and standard life cycle cost and statistical analysis techniques to provide decision makers with visual measures of the relative effectiveness and cost-effectiveness of the decision alternatives and a statistical curve which identifies areas of minimal or optimal funding, enabling decision makers to efficiently manage resources. The QAT is traceable and auditable, providing credibility and defensibility to decisions made with the tool.

### CROSS-REFERENCED APPLICATIONS

The present invention claims the priority of U.S. provisional applications Ser. No. 60/524,649, filed Nov. 24, 2003 and Ser. No. 60/545,528, filed Feb. 19, 2004.

### FIELD OF THE INVENTION

The present invention is directed to the field of formulating and resolving choice problems in a multi-criteria environment.

### BACKGROUND OF THE INVENTION

Decision making is a part of life. Everyone is faced with a multitude of decisions which must be made on a daily basis. These decisions are as easy and mundane as determining what food to eat on a particular day, what food should be purchased during a particular shopping trip as well as the types of clothes that that person should wear as well as to obtain. Many times, these decisions are made on an intuitive basis, without any defined rhyme or reason. For example, several pairs of shoes might be chosen to be tried on by an individual, and, based upon the style, how the shoe fits as well as how the shoe looks, would contribute to the decision making process.

However, as types of decisions to be made become more complex and their ramifications more permanent in nature, more time would be given to the decision making process. These type of more complex decisions, on a personal basis, could include the purchase of an automobile, the purchase of a house as well as the choice of a career. While intuition still plays a part in this decision making process, more time is given to weigh the pros and cons of these decisions as well as to compare alternatives.

Although, on a personal basis, these decisions are very important, they cannot be compared to the acquisition of a piece of technology costing in the order of millions or billions of dollars. Therefore, a system has been developed in which the decision making process becomes less intuitive and more regimented. This is important in substantiating a decision through a calculative process. Such a system was formulated by Thomas L. Saaty in the 1970's described as an analytical hierarchy process (AHP). This process includes breaking down a decision problem into a hierarchy of interrelated decision elements or criteria. This hierarchy would begin by stating an ultimate decision that had to be made, such as purchasing a new automobile. The various attributes of that automobile which will be used in the decision making process would then be enunciated. Lastly, a comparison would be made between similar types of attributes to determine which of these attributes would be the most important in reaching a conclusion. Consequently, this decision making process would lend itself to documentation, which can be used as the basis for making the final decision as well as providing credibility to the ultimate decision.

The need for traceable and quantitative management tools has increased due to current government emphasis on the war on terrorism and national priorities. These two emphases will spawn numerous decision alternatives in the government and private sectors. National and local needs and their accompanying requirements are changing at a rapid pace, and the array of new and evolving technologies that potentially meet these requirements is burgeoning. Competition for funding between current and future operational imperatives and future technological utility is building, and the cost and effectiveness of discretionary programs will increasingly come under the scrutiny of Congress, local governments, boards of directors, auditors and the like. Those responsible for translating needs into requirements and acquiring technologies or operational approaches to meet these requirements, will need credible and defensible decision processes to efficiently manage resources and defend their decisions. While the AHP developed by Saaty is a tool that can be used to defend and document the decision making process, this tool falls short of completely addressing all of the requirements of a decision making process. Although standard approaches for decision making offer considered costs and measures of operational improvement as separate decision criteria, no structured decision process is available that determines the relative effectiveness (traceable to a multi-criteria hierarchy) in parallel with life cycle costs, giving effectiveness as a function of cost.

### SUMMARY OF THE INVENTION

The present invention overcomes the deficiencies of the prior art by creating a quantitative assessment tool (QAT) as a mathematically rigorous process for evaluating and prioritizing decision alternatives in various environments such as operational management, resource allocation, bench marking, quality management, public policy, health care, strategic planning, or risk management, or the like. The present invention employs multi-criteria decision-theoretic methodologies and combines it with a standard life cycle course to provide a statistical analysis allowing decision makers to compare the relative effectiveness and cost effectiveness of decision alternatives.

The present invention utilizes a dual approach of calculating a raw effectiveness score for each of a number of alternatives and then combining this score with the life cycle cost necessitated by each of these alternatives. These two approaches are then combined in various graphical representations to provide an assessment tool combining both the raw effectiveness scores as well as the life cycle cost associated with each of the alternatives. These types of graphical outputs would then be used to compare the various alternatives provided to a decision maker as well as document the decision that the decision maker makes.

Other objects, characteristics and effects of the invention will be obvious from the following detailed description.

### BRIEF DESCRIPTION OF THE DRAWINGS

The present invention will be understood more fully from the detailed description given herein below and from the accompanying drawings of the preferred embodiment of the present invention, which, however, should not be taken to be limitative to the invention, but for explanation and understanding only.

FIG. 1 is a flow diagram showing the methodology of the present invention;

FIG. 2 is an example of a rudimentary decision hierarchy;

FIGS. 3 and 4 show higher level decision hierarchies of the FIG. 2 example;

FIG. 5 is an example of the alternative effectiveness results and net present costs;

FIG. 6 shows an example of cost-effectiveness results; and

FIG. 7 exhibits a cost-effectiveness curve;

FIG. 8 is a block diagram of the decision hierarchy of FIG. 4 including the local weights of each criteria;

FIG. 9 is a block diagram of the decision hierarchy of FIG. 4 including the global weights of each criteria;

FIG. 10 is a block diagram of the bottom criteria of the design hierarchy;

FIG. 11 is a table of the baseline and decision alternative of the hierarchy of FIG. 4;

FIG. 12 is a bar graph illustrating the effectiveness scores of the various alternatives;

FIG. 13 is a table listing the LCC associated with each of the alternatives;

FIG. 14 is a bar graph showing the cost effectiveness of each of the alternatives;

FIG. 15 is a graph illustrating the date point for each alternative; and

FIG. 16 is a cost effectiveness curve of the example shown in FIG. 4.

### DETAILED DESCRIPTION OF THE INVENTION

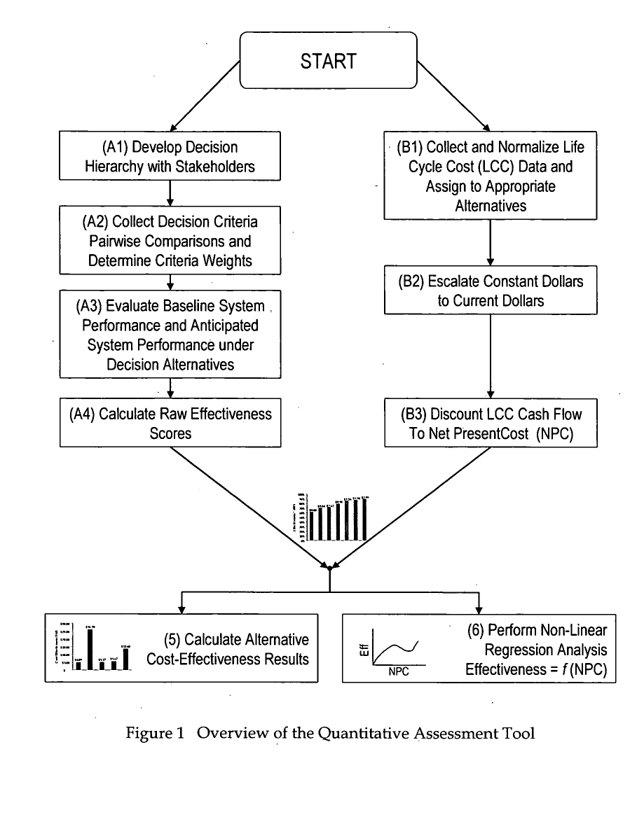

The process methodology is summarized in FIG. 1 in flow chart form. The left side of the flow chart represents a procedure based on the Analytic Hierarchy Process (AHP), used to determine the relative effectiveness of decision alternatives independently of cost. The right side of the flow chart describes the steps for determining the net present value of the life cycle cost (abbreviated as net present cost (NPC)). At the bottom of the flow chart, the cost-effectiveness of each decision alternative is calculated as a function of the relative effectiveness and the NPC. Additionally, the NPC and effectiveness of each alternative are graphed in a scatter plot, to which regression analysis is applied to determine the cost-effectiveness curve used to predict funding efficaciousness and determine optimal funding areas.

The steps of the left side of FIG. 1 would be used to assess the effectiveness of various alternatives, and is based on the AHP and is performed as follows:

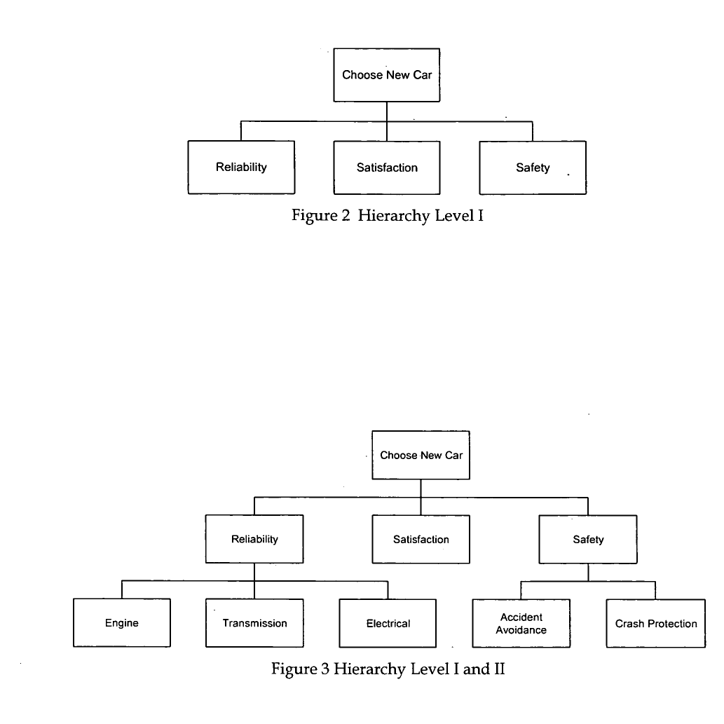

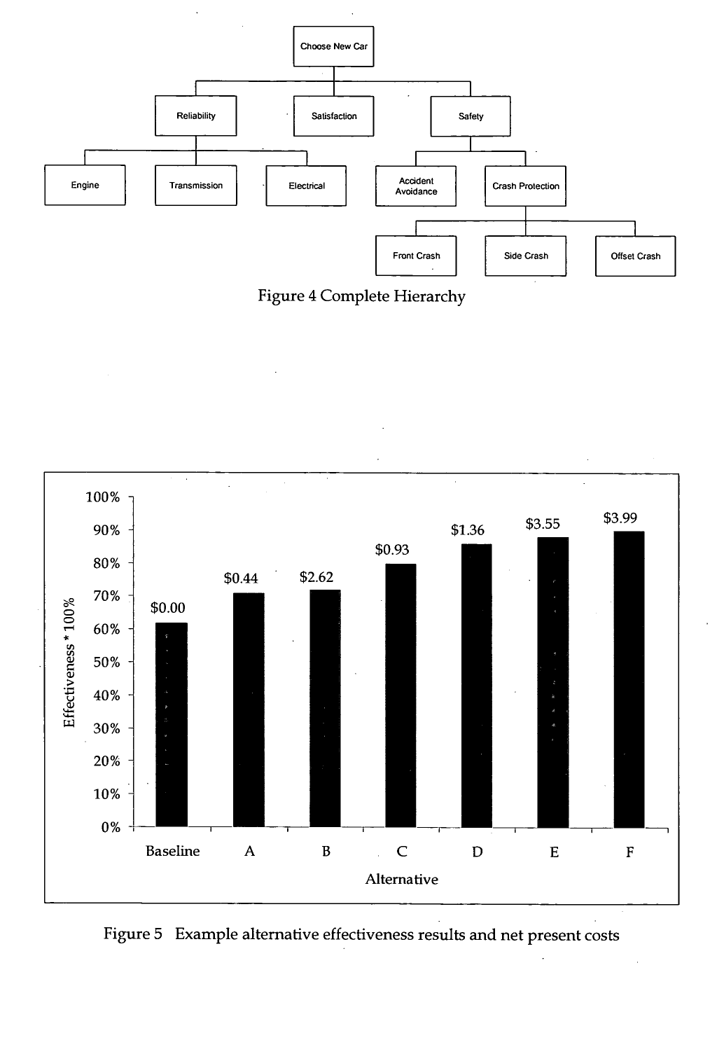

A hierarchy is developed at step A1 which models the decision criteria and their inter-relationships. An example of a rudimentary decision hierarchy is shown in FIG. 2. FIG. 2 shows a hierarchy for purchasing an automobile. FIGS. 3 and 4 illustrate the hierarchy of FIG. 2, including more criteria than is shown in FIG. 2.

After establishing the structure of the decision hierarchy, step A2 would determine weights for each branch of the hierarchy by making pairwise comparisons between criteria based upon their relative importance. The comparisons are made within each set of all criteria on one level which originate from the same criteria on the preceding level. Each set of comparisons is arranged into a matrix A in which entry aᵢⱼ is the relative worth of criteria i as compared to criteria j using a standard comparison methodology. The vector of weights w is determined as the solution to the equation Aw=λₘₐₓx. Here w is the eigenvector associated with the largest eigenvalue, λₘₐₓ, of the comparison matrix A. The components of w are normalized so that they sum to 1, resulting in a defensible assignment of weights that reflects a criteria's proportionate worth. These weights reflect the criteria's worth relative to its parent criteria, and are known as local weights. A criteria's global weight reflects its importance relative to the overarching goal (the topmost node in the hierarchy). Criteria on the first level have global weight equal to their local weight; for criteria on subsequent levels, global weight is determined by multiplying the criteria's local weight by the parent's global weight.

The set of decision alternatives, including the baseline (status quo, “do nothing”) are assessed against the criteria on the bottom level of the hierarchy (those criteria which have no further sub-criteria) in step A3. For each bottom-level criteria, each alternative is given a score reflecting its performance with respect to that criteria. Scoring can be done on any scale; an example is 1 to 10, where 1 reflects poor performance and 10 reflects excellent performance. Score values of 0 can be used to reflect that the alternative does not meet the criteria at all or is not relevant to the criteria.

For each alternative, according to step A4, including the baseline, the criteria scores are weighted according to the global criteria weights developed in step A2 by multiplying the score by the weight. The sum of these weighted criteria scores is the alternative's Effectiveness.

Although step A4 results in a tangible output relating to the effectiveness of various alternatives, these figures have little relevance without equating a cost to each of these alternatives. The right side of the flow chart of FIG. 1, addresses this feature.

The steps on the right-hand side of FIG. 1, are based on standard cost estimating techniques. Each alternative that gives enhanced relative effectiveness has an associated life cycle cost. These costs are calculated using standard cost analysis methodology. The cost of the baseline alternative is $0.

In the cost analysis, all phases of the life cycle are addressed independently as appropriate, to include research and development, production and fielding, operation and support, and retirement. Step B1 collects cost data for each of the alternatives under each phase of the life cycle, in constant dollars, for each year that costs will be incurred.

For each alternative, step B2 would convert the cost stream determined in step B1 to current year dollars by inflating each year of costs using the appropriate index.

NPC is obtained in step B3 by discounting each element of the cost stream to its present value and then summing these discounted costs into the total net present cost.

The bar graph in FIG. 5 shows the results of these two sets of analysis for several alternatives, labeled A through F, and the baseline. It is noted that this bar graph is not related to the decision hierarchy of FIGS. 2, 3 and 4. The bars indicate each alternative's effectiveness score. The alternative's NPC is shown above its effectiveness bar, in millions of dollars ($M).

A review of this graph would indicate that Alternative F is the most effective. However, the cost associated with this alternative, would be much greater than, for example, Alternatives A and C. Based upon the length of the bars in FIG. 5 and the NPCs associated with each bar, a decision can be made to opt for a particular Alternative.

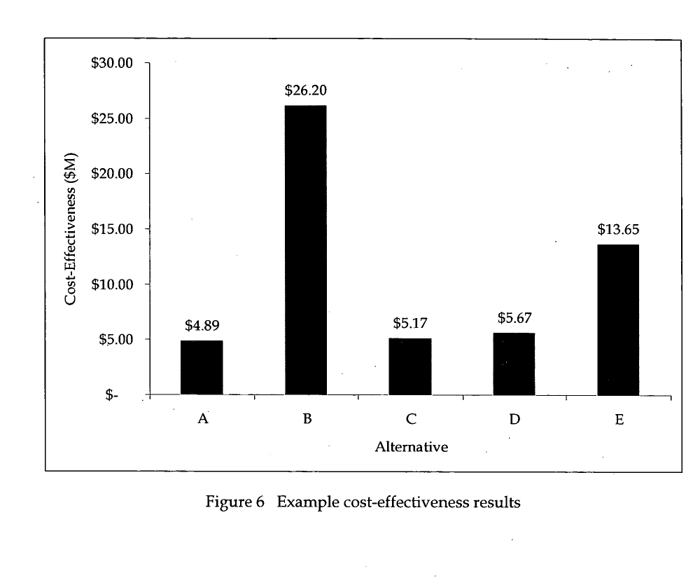

The final two steps in FIG. 1 make use of the results of the two sets of analysis. Step (5) uses the Effectiveness and NPC results to compute each alternative's cost-effectiveness. This is shown in FIG. 6. This figure is also not directed to the example shown in FIGS. 2, 3 and 4. This step does not apply to the baseline alternative. Cost-effectiveness is determined by first computing the alternative's net effectiveness gain, the difference between the alternative's effectiveness score and the baseline effectiveness score. This difference will be non-zero if the alternative represents any improvement over the status quo. The alternative's cost-effectiveness is then computed as the ratio of its NPC to its net effectiveness gain: Cost-Effectiveness=NPC/ΔEffectiveness. The bar graph in FIG. 6 shows the cost-effectiveness of each decision alternative. A smaller cost effectiveness value is more advantageous, representing less cost per unit gain in effectiveness. FIG. 6 shows, for example, that although Alternative B provides a greater increase in effectiveness that Alternative A, its large cost makes it less cost-effective. Cost effectiveness can be computed for each competing alternative that is expected to meet some portion of the requirements.

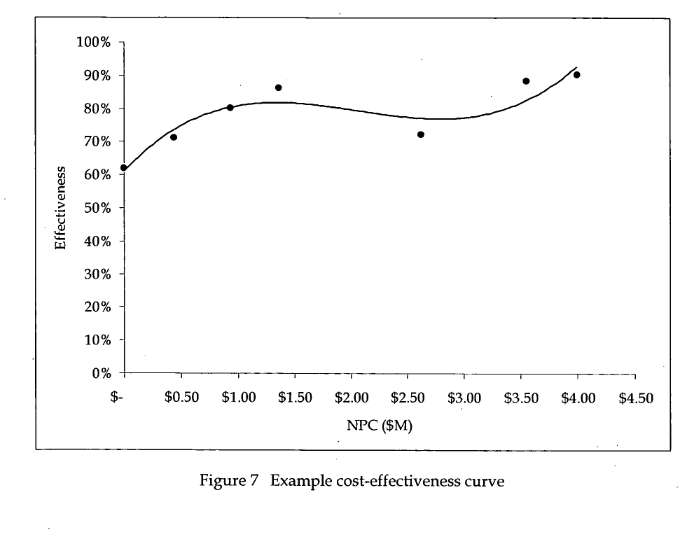

Step (6) in FIG. 1 uses the collected data to predict the optimal areas of funding. This is done by making a scatter plot of the Effectiveness and NPC values, and applying regression analysis to find a curve which models the data. This cost effectiveness curve (statistical model) is often overlooked or never identified, but can show many kinds of information, including areas of diminishing returns for increasing costs, and areas of optimal investment. FIG. 7, for example, shows a “dip” in the curve indicating a region of cost where further investment would be ill-advised. The first derivative of any point on the curve provides the marginal change in effectiveness per unit cost.

Using the method outlined in FIG. 1, we now give a concrete example utilizing the decision hierarchy shown in FIGS. 2, 3 and 4. For the purposes of illustration, this example is simpler than an expected typical application of the QAT. It applies the QAT to determine the best of three new cars to purchase, using data from the annual Consumer Reports (CR) “Cars” issue. This annual report, issued every April, contains vehicle profiles of almost every major car model, a detailed section on automotive safety, and the reliability history of more than 200 car models. This example will evaluate three different cars: A, B, and C.

A hierarchy is developed at Step A1 of FIG. 1. The three main criteria for our imaginary car-buyer are Reliability, Satisfaction, and Safety. These criteria form the level I hierarchy shown in FIG. 2. Reliability ratings are based on surveys of typical trouble spots, three of which are used in this-example (engine, transmission, and electrical system). Safety assessments are based on accident avoidance and crash protection information. These sub-criteria are listed on the second level of the hierarchy (FIG. 3). Finally, crash protection ratings are given for three different types of crashes: full-frontal, side-impact, and offset-frontal. With these sub-criteria on the third level, the hierarchy is complete (FIG. 4).

Decision criteria pairwise comparisons are collected and the criteria weights are determined at step A2. In this step, related criteria are compared to each other, two at a time, and a numerical value is assigned to the comparison. This example will use the standard AHP 1-9 scale for comparison values, with meanings as follows:

| Value | Meaning |
|---|---|
| 1 | The two criteria are equally important |
| 3 | One criteria is moderately more important |
| | than the other |
| 5 | One criteria is strongly more important |
| | than the other |
| 7 | One criteria is very strongly more |
| | important than the other |
| 9 | One criteria is extremely more important |
| | than the other |
| Even | Used to compromise judgments |
| numbers | |

On the top level of the hierarchy, Reliability, Satisfaction, and Safety are compared to each other as follows:
Reliability is judged to be moderately more important than Satisfaction, yielding a judgment value of 3.
Safety is judged to be between moderately and strongly more important than Reliability, a judgment value of 4.

Safety is judged to be strongly more important than satisfaction, a value of 5.

These numbers are arranged into a matrix as follows, where an entry indicates the value of the row criterion as compared to the column criterion:

| | Reliability | Satisfaction | Safety |
|---|---|---|---|
| Reliability | | 3 | |
| Satisfaction | | | |
| Safety | 4 | 5 | |

Since a criteria is necessarily equally important to itself, the diagonal of the matrix is populated with 1's:

| | Reliability | Satisfaction | Safety |
|---|---|---|---|
| Reliability | 1 | 3 | |
| Satisfaction | | 1 | |
| Safety | 4 | 5 | 1 |

Finally, cells representing opposite judgments are filled with reciprocal values:

| | Reliability | Satisfaction | Safety |
|---|---|---|---|
| Reliability | 1 | 3 | ¼ |
| Satisfaction | ⅓ | 1 | ⅕ |
| Safety | 4 | 5 | 1 |

The components of the normalized principal eigenvector of this matrix are the weights of these criteria. Although finding the eigenvector can be computationally intensive, it has been shown that a good approximation is to take the geometric mean of each row. Therefore, in this case, the first component of the eigenvector is the cube root of 1*3* (¼): 0.909. The second component of the eigenvector is [(⅓)*1* (⅕)] (⅓)=0.405, and the third component, computed similarly, is 2.714. The eigenvector is normalized by dividing each component by the sum of the components, so that in the normalized eigenvector, each component represents its proportion to the whole. Since the sum of the three elements is 0.909+0.405+2.714=4.028, the three components of the normalized eigenvector are

| | |
|---|---|
| First component: | 0.909/4.208 = 0.226 |
| Second component: | 0.405/4.208 = 0.101 |
| Third component: | 2.714/4.208 = 0.674. |

Therefore, the weight of the criteria Reliability is 0.226, the weight of Satisfaction is 0.101, and the weight of Safety is 0.674.

There are two sets of related criteria on the second level of the hierarchy as shown in FIG. 3: Engine, Transmission, and Electrical; and Accident Avoidance and Crash Protection. With regard to Safety, Accident Avoidance is judged to be moderately to strongly more important than Crash Protection, a judgment value of 4. Thus the judgment matrix for this set of criteria is

| | Accident | Crash |
|---|---|---|
| | Avoidance | Protection |
| Accident | 1 | 4 |
| Avoidance | | |
| Crash | ¼ | 1 |
| Protection | | |

The geometric mean of the first row is 2; of the second row, ½. Their sum is 2.5, so the weight of Accident Avoidance with respect to the parent criteria Safety is 2/2.5=0.800, and the weight of Crash Protection with respect to the parent criteria Safety is 0.5/2.5=0.200.

Weights relative to parent criteria are computed in the same way for the remaining two sets of related criteria in the hierarchy as illustrated in FIG. 4:
Engine, Transmission, Electrical (parent criteria is Reliability).
Front, Side, Offset (parent criteria Crash Protection).

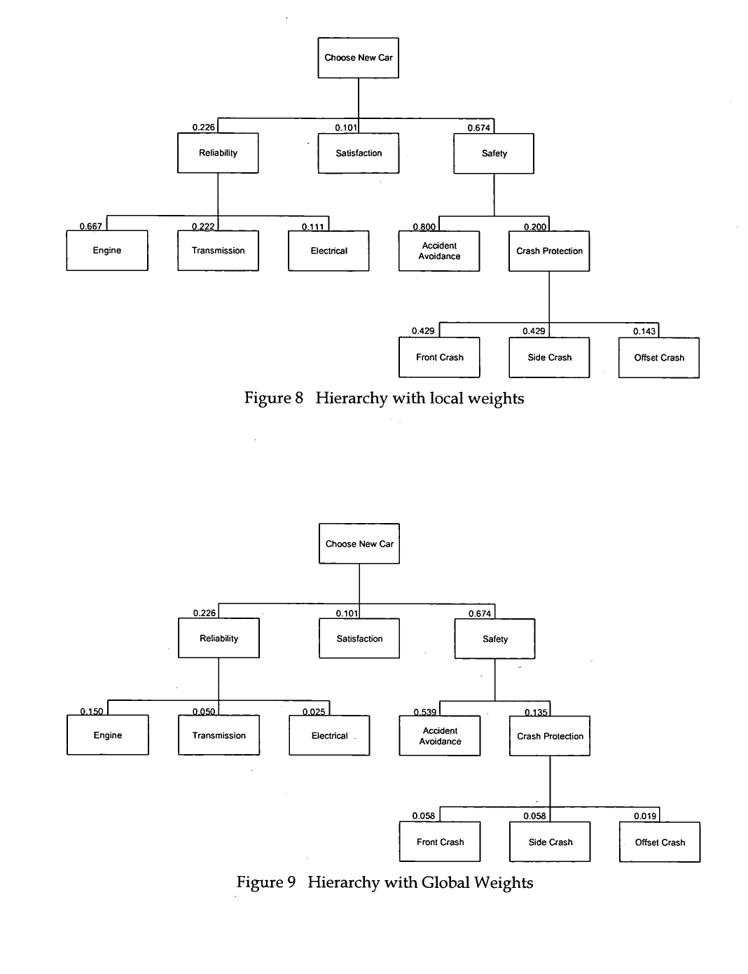

The weight of any criteria relative to its parent criteria is called the local weight of the criteria. The hierarchy with all local weights is shown in FIG. 8. The criteria 's weight relative to the overarching goal is called the global weight. These global weights are found by multiplying the criteria's local weight by the parent's local weight, then by the local weight of the parent of the parent, and so on, until the goal is reached. For example, the global weight of the criteria Engine is 0.667*0.226=0.150. The global weight of side crash is 0.429*0.200*0.674=0.058. The hierarchy with global weights is shown in FIG. 9.

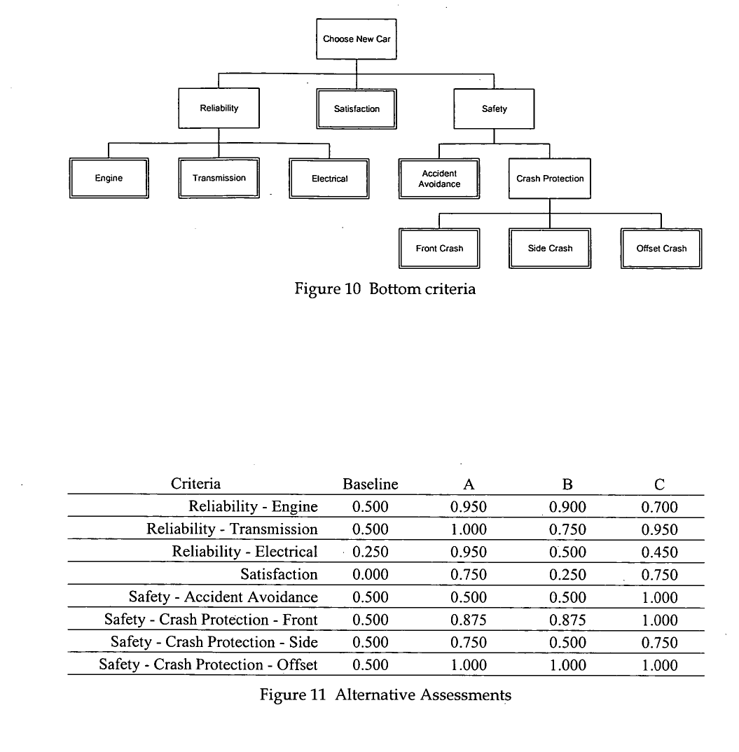

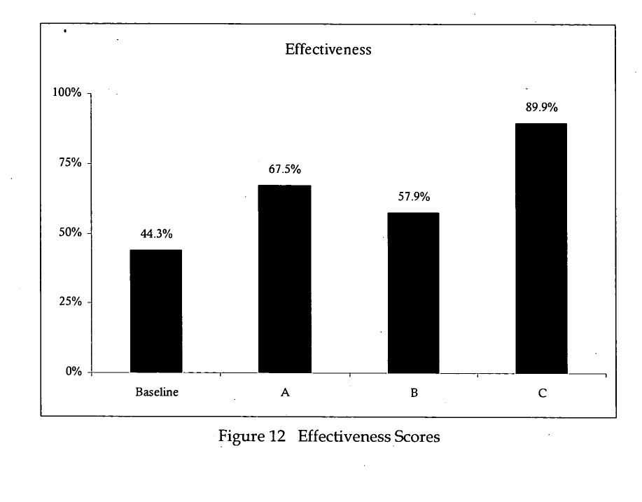

The bottom criteria of the hierarchy as shown in FIG. 10 are those criteria which have no sub-criteria underneath them: Engine, Transmission, Electrical, Satisfaction, Accident Avoidance, Front Crash, Side Crash, and Offset Crash. These bottom criteria are denoted by the double boxes. Note that the global weights of the bottom criteria sum to 1. These bottom criteria represent every piece of the decision.

Once the weights of the hierarchy criteria have been determined, the next step is to evaluate the baseline system (status quo) and decision alternatives with respect to the bottom criteria of the hierarchy as shown in Step A3.

Recall that the decision alternatives in this example are the three new cars A, B, and C. The baseline is the car the imaginary decision-maker is assumed to currently own. The example uses data from the April 2004 Consumer Reports (CR) to assess the four cars. Evaluation should be done using a scale of numbers between 0 and 10. It is often helpful to think of these in percentages; i.e., the scale is 0% and 100%. For example, an assessment scale with three values, Bad, Average, and Good, can be represented as 0%, 50%, and 100%. A rating set of integers between 1 and 10 can be represented as 10%, 20%, . . . , 100%.

Data for the three Reliability criteria, Engine, Transmission, and Electrical, comes from the CR Reliability Ratings of past model years. Each model year is given one of five ratings with respect to each of the trouble spots. In this example, we assigned numerical values to CR's five ratings as follows: We assigned their top rating an assessment value of 1 (100%); the second-best rating was assigned a value of 0.75 (75%); their middle rating was taken as 0.50; their second-to-worst rating, 0.25; and the worst, 0. We used the ratings of the model year of the baseline car for the baseline assessment, and we averaged the values of the past five years (1999-2003) to obtain an overall rating for the new cars. This gave the following ratings:

| | Baseline | A | B | C |
|---|---|---|---|---|
| Reliability - Engine | 0.5 | 0.95 | 0.9 | 0.7 |
| Reliability - Transmission | 0.5 | 1 | 0.75 | 0.95 |
| Reliability - Electrical | 0.25 | 0.95 | 0.5 | 0.45 |

With regard to the Satisfaction criterion, data for the new cars was taken from the CR Vehicle Profiles. Again, the CR five-value rating scale was mapped to 1, 0.75, 0.5, 0.25, and 0. The assessment of the baseline car was taken as 0, no satisfaction. The four cars had the following Satisfaction ratings:

| | Baseline | A | B | C |
|---|---|---|---|---|
| Satisfaction | 0 | 0.75 | 0.25 | 0.75 |

Accident Avoidance data for the new cars was taken from the CR Safety Assessment section, which presents five-value ratings from CR's own testing, mapped to the same values as before. Assessments of the new cars' performance with regard to the Crash Protection criteria were taken from the Vehicle Profiles. The Front Crash and Side Crash data was provided by the National Highway Traffic Safety Administration, which uses a five star rating system, which we converted to the same values as CR's five ratings (0, 0.75, 0.5, 0.25, and 0). The full-frontal scores are based on driver's-side crashes and passenger-side crashes; if the two differed, we averaged the values. Offset Crash ratings were provided by the Insurance Institute for Highway Safety, which uses a four-value rating scale: Good, Acceptable, Marginal, or Poor. We judged these to be equivalent to 1, 0.66 (66%), 0.33 (33%), and 0. All assessments for the baseline car represent the decision-maker's opinion. The following table shows the scores for the four cars with respect to each of these criteria:

| | Baseline | A | B | C |
|---|---|---|---|---|
| Safety - Accident Avoidance | 0.5 | 0.5 | 0.5 | 1 |
| Safety - Crash Protection - | 0.5 | 0.875 | 0.875 | 1 |
| Front | | | | |
| Safety - Crash Protection - | 0.5 | 0.75 | 0.5 | 0.75 |
| Side | | | | |
| Safety - Crash Protection - | 0.5 | 1 | 1 | 1 |
| Offset | | | | |

The entire set of ratings is given in FIG. 11.

To determine a car's overall effectiveness, as required by step A4, the car's score under each criteria is multiplied by that criteria's global weight. For example, for car A, its score under Engine, 0.95, is multiplied by Engine's global weight, 0.150, to get 0.143. These values are summed to obtain the overall effectiveness score. Car A's effectiveness score is

| | |
|---|---|
| (0.95 * 0.143) + | [Reliability - Engine] |
| (1 * .05) + | [Reliability - Transmission] |
| (0.95 * .025) + | [Reliability - Electrical System] |
| (0.75 * 0.101) + | [Satisfaction] |
| (0.5 * 0.539) + | [Safety - Accident Avoidance] |
| (0.875 * 0.058) + | [Safety - Crash Protection - Front] |
| (0.75 * 0.058) + | [Safety - Crash Protection - Side] |
| (1 * 0.019) = | [Safety - Crash Protection - Offset] |
| 0.675 | |

The effectiveness score can also be thought of in terms of percentages, so car A's effectiveness score is 67.5%. The list of all effectiveness scores is:

| | |
|---|---|
| Baseline: | 44.3% |
| Car A: | 67.5% |
| Car B: | 57.9% |
| Car C: | 89.9% |

These figures are shown in the bar graph of FIG. 8.

The right side of the QAT process of FIG. 1 shows the steps for calculating the net present value (NPV) of the life cycle cost (LCC) of each decision alternative. Life cycle costs address each step in the life cycle of an acquisition, including procurement, maintenance and upkeep, and disposal costs. The net present value of a cost accounts for inflation and the time value of money. The baseline has no cost.

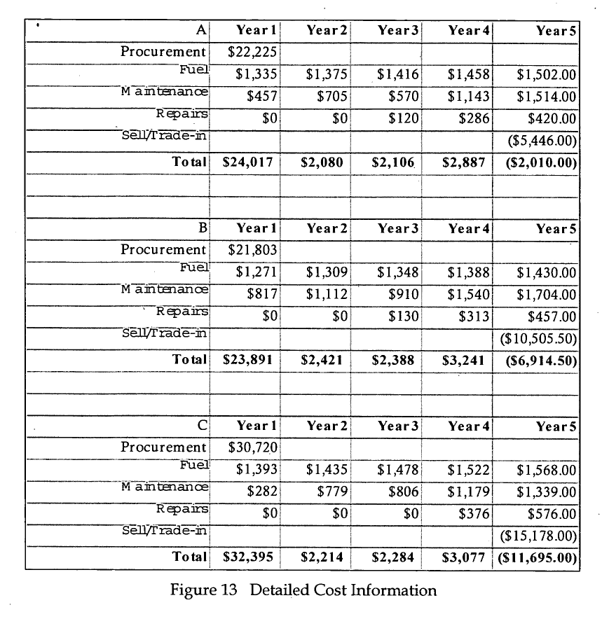

We used a popular automobile evaluation web site to obtain estimated costs for the out-years of car ownership at step B1. These costs are presented in constant dollars; that is, they do not address the decreasing purchasing ability of a dollar over time. This example looks at the initial purchase price, estimated annual fuel, maintenance and repair costs, and the estimated sale or trade in value at the end of five years (purchase price minus depreciation). These costs are detailed in FIG. 13 and summarized here:

| Base Cost (FY04$) | 2004 | 2005 | 2006 | 2007 | 2008 |
|---|---|---|---|---|---|
| Car A | $24,017 | $2,080 | $2,106 | $2,887 | ($2,010) |
| Car B | $23,891 | $2,421 | $2,388 | $3,241 | ($6,915) |
| Car C | $32,395 | $2,214 | $2,284 | $3,077 | ($11,695) |

These constant dollar figures are escalated to account for inflation by multiplying by the appropriate composite inflation index as required by step B2. This example uses the following inflation indices:

| | |
|---|---|
| 2004: | 1.0000 (no inflation) |
| 2005: | 1.0336 |
| 2006: | 1.0515 |
| 2007: | 1.0515 |
| 2008: | 1.0927 |

For example, under inflation, the estimated cost of owning Car B in 2006 is $2,388*1.0515=$2,511. The inflated costs are:

| Inflated | 2004 | 2005 | 2006 | 2007 | 2008 |
|---|---|---|---|---|---|
| Car A | $24,017 | $2,150 | $2,214 | $3,093 | ($2,196) |
| Car B | $23,891 | $2,502 | $2,511 | $3,472 | ($7,555) |
| Car C | $32,395 | $2,288 | $2,402 | $3,297 | ($12,779) |

The net present value of a cost accounts for the time value of money, and is determined by converting the forecasted inflated amounts to economically comparable amounts in the present time. This is done by applying a discount rate—an interest rate that closely approximates the current cost of money in the financial marketplace. This example uses a discount rate of 4.2%. Costs of 2005, one year in the future, are discounted by 4.2% For example, the discounted worth of Car C's 2005 cost is $2,288/0.042=$2,196. Because 2006 is two years in the future, 2006 costs are discounted by 4.2%². For example, the discounted value of Car C's 2006 cost is $2,402/(0.042²)=$2,212. 2007 costs are discounted by 4.2%³, and so on. The net present value of each car 's annual costs are:

| NPV | 2004 | 2005 | 2006 | 2007 | 2008 |
|---|---|---|---|---|---|
| Car A | $24,017 | $2,063 | $2,040 | $2,734 | ($1,863) |
| Car B | $23,891 | $2,401 | $2,313 | $3,069 | ($6,409) |
| Car C | $32,395 | $2,196 | $2,212 | $2,914 | ($10,840) |

The total net present value of the life cycle cost (NPV LCC, or just NPC, net present cost) is the sum of the net present value of each year. Car C's NPC is
$32,395+$2,196+$2,212+$2,914−$10,840=$28,877.

The NPC's of the three decision alternatives are:

| | |
|---|---|
| Car A: | $28,991 |
| Car B: | $25,265 |
| Car C: | $28,877. |

Although the initial purchase prices of Cars A and C differ by almost $8,500 (see FIG. 13), they have almost the same NPC, due largely to the fact that Car C loses a smaller percentage of its worth to depreciation than Car A.

Steps (5) and (6) of the QAT combine the effectiveness and cost results into two forms of analysis. Step (5) computes an alternative's cost-effectiveness by considering the net effectiveness gain produced by each alternative. This gain is calculated as the difference between the alternative 's effectiveness score and the baseline effectiveness score. The three alternatives yield the following net gains:

| | |
|---|---|
| Car A: | 67.5% − 44.5% = 23.1% |
| Car B: | 57.9% − 44.5% = 13.5% |
| Car C: | 89.9% − 44.5% = 45.6% |

An alternative's cost-effectiveness is the ratio of the alternative's NPC to its improvement. In other words, it is the cost per unit gain in effectiveness. A smaller cost-effectiveness represents less cost per percent gained; a larger cost-effectiveness demonstrates more money spent for each percent gained. The alternatives' cost-effectiveness values are

| | |
|---|---|
| Car A: | $28,991/23.1 = $1,252 |
| Car B: | $25,265/13.5 = $1,866 |
| Car C: | $28,877/45.6 = $634. |

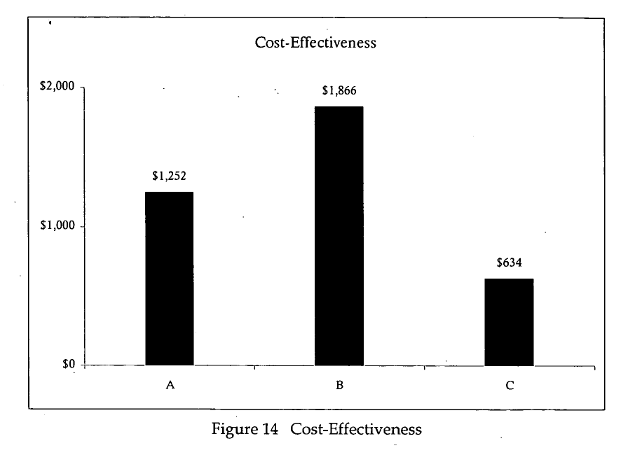

The fact that although cars A and C have similar NPC but car C has a noticeably superior effectiveness score manifests itself in a large cost-effectiveness value for car A and a small cost-effectiveness value for car C. The smaller cost-effectiveness score indicates that car C is providing more value for the money. Cost-effectiveness scores are shown in the bar graph of FIG. 14.

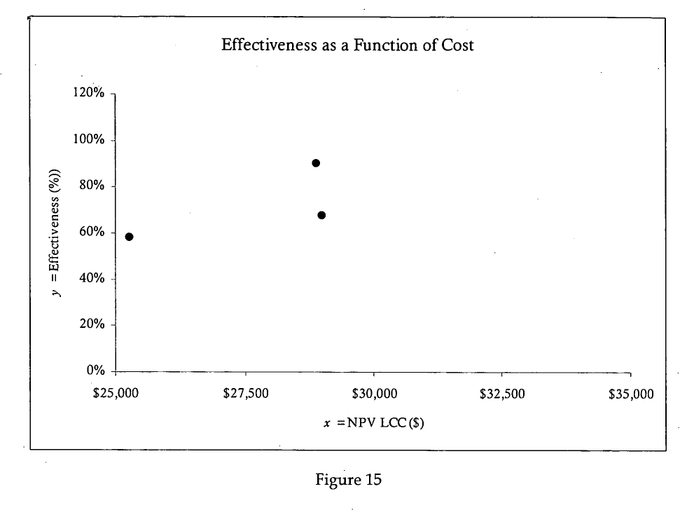

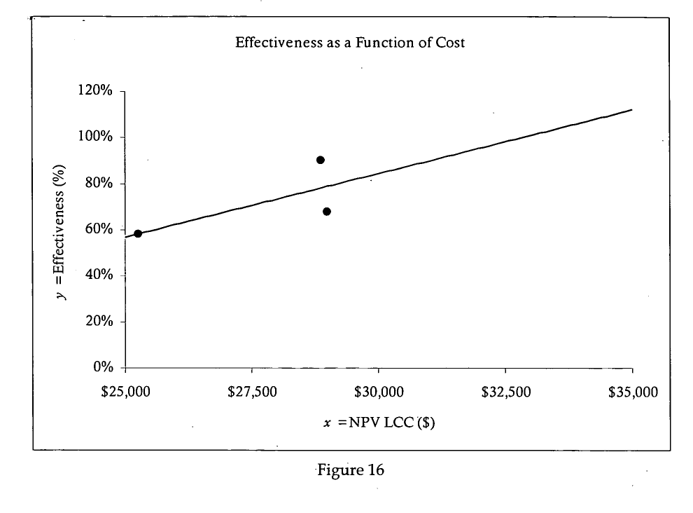

Step (6) shows cost and effectiveness in two dimensions and considers effectiveness as a function of cost. The data point (cost, effectiveness) is plotted for each alternative. This is shown in FIG. 15. Regression analysis is used to determine a curve that models the data. (A typical application of the QAT would consider many more alternatives than this example, and the use of regression analysis would be more appropriate than on a three-point data set.) In general on this scatter plot, local maxima identify areas of optimal funding. Intervals over which the function is decreasing indicate areas where additional funding is not advised. The first derivative of the curve indicates the rate of improvement per additional unit of funding; neighborhoods-over which the first derivative is increasing have increasing returns for additional spending, while neighborhoods over which the first derivative is decreasing provide diminishing returns for additional spending. A decision maker may enter available funding into the equation as the independent variable and calculate the optimal achievable gain in relative effectiveness at that funding level. Conversely, a strategist may postulate the minimum acceptable gain in effectiveness and use the inverse cost effectiveness function to calculate the minimal required investment. In this example, because there are only three data points, the most appropriate fit is a line. This is shown in FIG. 16. This line crosses the 100% line around $32,800. An informal observation of the graph shows that the buyer could probably find a car which meets all of the requirements for a net present cost in the neighborhood of $32,500. This information could be used to target a current-dollar spending level if the buyer wanted to look at additional alternatives.

Of the three alternatives under consideration in the example, since Car A provides less effectiveness than Car C for slightly more cost, it is clearly not a good choice. Car C provides better effectiveness than Car B, and although it costs more than Car B, its better cost-effectiveness (FIG. 14) shows that it is a better value. Therefore, Car C would be the best car for purchase.

Armed with this information, a decision maker may enter available funding into the equation as the independent variable and calculate the optimal achievable gain in relative effectiveness at that funding level. Conversely, a strategist may postulate the minimum acceptable gain in effectiveness and use the inverse cost effectiveness function to calculate the minimal required investment.

While various embodiments of the present have been described above, it should be understood that they have been presented by way of example only, and not limitation. Thus the breadth and scope of the present invention should not be limited by any of the above-described exemplary embodiments, but should be defined only in accordance with the following claims and their equivalents.

1. A method of quantitatively comparing a number of alternatives to solve a choice problem, comprising the steps of:
deciding upon an analytic hierarchy to be used to solve the choice problem, said analytic hierarchy including a plurality of primary criteria;
pairwise comparing each of said primary criteria to each other to determine the relative importance of each of said primary criteria, obtaining a comparison numerical value for each comprising
determining the relative weight of each of said primary criteria, based upon said pairwise comparison step;
estimating the weights of each of the alternatives for each of said primary criteria;
determining the percentage of effectiveness of each of the alternatives by aggregating the relative weights of each of said primary criteria with said weights of each of the alternatives for each of said primary criteria to obtain a set of numerical ratings for each of the alternatives as a percentage of effectiveness for each of the alternatives;
determining a baseline percentage effectiveness;
estimating a cost of each of the alternatives for each of a plurality of time periods;
calculating the net effectiveness gain of each of the alternatives as a difference of said percentage of effectiveness of each of the alternatives and said baseline percentage of effectiveness;
calculating the cost effectiveness of each of the alternatives as a ratio of said cost of each of the alternatives and said net effectiveness gain of each of the alternatives; and
visually associating said cost effectiveness of each of the alternatives with each other.

2. The method in accordance with claim 1, wherein said visually associating step includes producing a bar graph of set numerical ratings as percentage of effectiveness for each of the alternatives.

3. The method in accordance with claim 1, wherein said visually associating step includes producing a bar graph showing the cost/per percentage gain of each of the alternatives.

4. The method in accordance with claim 1, wherein said visually associating step includes producing a scatter plot of the effectiveness of each of the alternatives as a function of cost.

5. The method in accordance with claim 1, further including the steps of:
providing at least one pair of secondary criteria associated with at least one of said primary criteria;
pairwise comparing each of said secondary criteria associated with a primary criteria with each other to determine the relative importance of each of said secondary criteria, obtaining a numerical value for each of said secondary criteria; and
determining the relative weights of said primary criteria, based upon said pairwise comparison step of said secondary criteria.

6. The method in accordance with claim 1, further including the step of producing a normalized value for each of said numerical values of said primary criteria.

7. The method in accordance with claim 5, further including the step of producing a normalized value for each of the numerical values of said secondary criteria.

8. The method in accordance with claim 6, further including the step of producing a normalized value for each of the numerical values of said secondary criteria.

9. The method in accordance with claim 5, wherein said step of determining the percentage of effectiveness of each of the alternatives includes determining a global weight of each of said secondary criteria by multiplying the numerical value of each of said secondary criteria with the numerical value of its associated primary criteria.

10. The method in accordance with claim 4, wherein a curve is superimposed over said scatter plot.

11. The method in accordance with claim 10, wherein said scatter plot is a non-linear curve.

12. The method in accordance with claim 10, wherein the first derivative of said curve is a function of said cost-effectiveness.

13. The method in accordance with claim 11, wherein the first derivative of said curve is a function of said cost-effectiveness.

14. The method in accordance with claim 1, wherein said step of estimating the cost of each alternative includes the step of adjusting the cost of each of the alternatives for each of said time periods for inflation, to produce an inflation figure for each of said time periods.

15. The method in accordance with claim 14, further including the step of adjusting each of said inflation figures to economically comparable amounts in the present time, thereby producing a net present cost for each of the alternatives.
